(19) United States
(12) Patent Application Publication
(10) Pub. No.: US 2025/0042289 A1
(43) Pub. Date: Feb. 6, 2025

(54) MANAGEMENT DEVICE, MANAGEMENT SYSTEM, AND MANAGEMENT METHOD

(71) Applicant: NEC Corporation, Minato-ku, Tokyo (JP)

(72) Inventors: Hideki MURAMATSU, Tokyo (JP); Masaru YANAI, Tokyo (JP); Motoharu OHTAKE, Tokyo (JP); Sawaka SEKI, Tokyo (JP); Noritsugu YAMANAKA, Tokyo (JP); Natsumi YOKOYAMA, Tokyo (JP); Yoshikatsu NIWA, Tokyo (JP); Kosei KOBAYASHI, Tokyo (JP); Hideki KIKKAWA, Tokyo (JP); Hiroaki AMINAKA, Tokyo (JP)

(73) Assignee: NEC Corporation, Minato-ku, Tokyo (JP)

(21) Appl. No.: 18/713,263

(22) PCT Filed: Dec. 7, 2021
(86) PCT No.: PCT/JP2021/044903

§ 371 Date: May 24, 2024

(51) Int. Cl. B60L 53/64; B60L 53/63; B60L 53/66; B60L 53/67; B60L 53/68

(52) U.S. Cl. CPC B60L 53/64; B60L 53/63; B60L 53/66; B60L 53/67; B60L 53/68

(57) ABSTRACT

A management apparatus includes: an extraction section that, on the basis of an electric power quantity of each of the plurality of electric vehicles, the electric power quantity being indicated by electric power quantity information, extracts at least one of the electric vehicles that is among the plurality of electric vehicles and that corresponds to an electric power state of one or more of the plurality of charging facilities, the one or more being included in a target area; and a transmission section that transmits information pertaining to the target area to at least one of the at least one of the electric vehicles that has been extracted by the extraction section.

### TECHNICAL FIELD

The present invention relates to a management apparatus, a management system, and a management method.

### BACKGROUND ART

An electric vehicle (EV) equipped with a storage battery has recently been used. An electric vehicle is charged with necessary electric power with use of a charging facility provided with, for example, a charging station. Patent Literature 1 discloses that a management apparatus receives a search request from a mobile terminal and searches for a mobile charging station in accordance with a remaining battery capacity of an electric vehicle and position information of the electric vehicle on the basis of position information of each charging station which position information is stored in advance in a storage section of the management apparatus.

Patent Literature 2 discloses that proximity (position) information, SOC level information, price suitability (suggested electricity selling price) information, and a cooperation frequency are set as parameters, and a charging facility uses these parameters to efficiently solicit charging and discharging quantities from an EV.

### CITATION LIST

### Patent Literature

### [Patent Literature 1]

Japanese Utility Model Registration No. 3233496

### [Patent Literature 2]

International Publication No. 2011/077780

### SUMMARY OF INVENTION

### Technical Problem

In order to carry out stable charging with respect to an electric vehicle and prevent an electric power loss, a charging facility is required to store constant electric power at all times, but a quantity of electric power stored in the charging facility can be changed due to charging for an electric vehicle and/or a change in quantity of electric power supplied from a power plant. However, Patent Literature 1 does not consider an electric power state of a charging facility, and thus may make it impossible to cope with a change in quantity of electric power stored in the charging facility.

Further, Patent Literature 2 discloses that a charging facility uses parameters to efficiently solicit charging and discharging quantities from an EV. However, as in the case of Patent Literature 1, Patent Literature 2 does not consider an electric power state of the charging facility, and thus may make it impossible to cope with a change in quantity of electric power stored in the charging facility.

An example aspect of the present invention has been made in view of the above problems, and an example object thereof is to provide a technique that makes it possible to carry out management such that electric power charging and discharging of an electric vehicle are suitably carried out in accordance with a change in quantity of electric power stored in a charging facility.

### Solution to Problem

A management apparatus according to an example aspect of the present invention includes: an acquisition means for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area; an extraction means for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and a transmission means for transmitting information pertaining to the target area to at least one of the at least one electric vehicle extracted by the extraction means.

A management system according to an example aspect of the present invention includes: an acquisition means for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area; an extraction means for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and a transmission means for transmitting information pertaining to the target area to at least one of the at least one electric vehicle extracted by the extraction means.

A management method according to an example aspect of the present invention includes: acquiring (i) electric power state information indicative of an electric power state in a target area including one or more charging facilities and (ii) electric power quantity information indicative of an electric power quantity of each of a plurality of electric vehicles capable of being subjected to charging and discharging in the target area; extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and transmitting information pertaining to the target area to at least one of the extracted at least one electric vehicle.

### Advantageous Effects of Invention

An example aspect of the present invention makes it possible to carry out management such that electric power charging and discharging of an electric vehicle are suitably carried out in accordance with a change in quantity of electric power stored in a charging facility.

### BRIEF DESCRIPTION OF DRAWINGS

FIG. 1 is a diagram illustrating a configuration of a management apparatus according to a first example embodiment of the present invention together with exemplary charging facilities and electric vehicles.

FIG. 2 is a flowchart showing a flow of a management method according to the first example embodiment of the present invention.

FIG. 3 is a diagram illustrating a configuration of a management system according to the first example embodiment of the present invention together with exemplary charging facilities and electric vehicles.

FIG. 4 is a diagram illustrating a configuration of an information processing apparatus according to a second example embodiment of the present invention together with exemplary charging facilities and electric vehicles.

FIG. 5 is a diagram illustrating an example of electric power state information, charging facility position information, and selling price and purchase price information.

FIG. 6 is a diagram illustrating an example of electric power quantity information and electric vehicle position information.

FIG. 7 is a diagram illustrating an example of information pertaining to a target area.

FIG. 8 is a diagram illustrating a configuration of an information processing apparatus according to a third example embodiment of the present invention together with exemplary charging facilities and electric vehicles.

FIG. 9 is a diagram illustrating examples of assignment of priorities.

FIG. 10 is a diagram illustrating a configuration of an information processing apparatus according to a fourth example embodiment of the present invention together with exemplary charging facilities and electric vehicles.

FIG. 11 is a block diagram illustrating a configuration of a computer functioning as each of the management apparatus and the information processing apparatus according to the example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for an example embodiment described later. Note that in this overview, reference numerals in the drawings are assigned, for convenience, to respective elements as an example for easier understanding, and are not intended to limit the present invention to aspects illustrated in the drawings. Furthermore, a direction in which connecting lines between blocks in, for example, the drawings to be referred to in the following description extend includes both a single direction and two directions. A unidirectional arrow schematically illustrates a flow of a main signal (data) and is not intended to exclude bidirectionality. Moreover, a point of connection between an input and an output of each of the blocks in the drawings may be configured to be provided with a port or an interface. However, such a configuration is not illustrated.

### <Management Apparatus 1 According to First Example Embodiment>

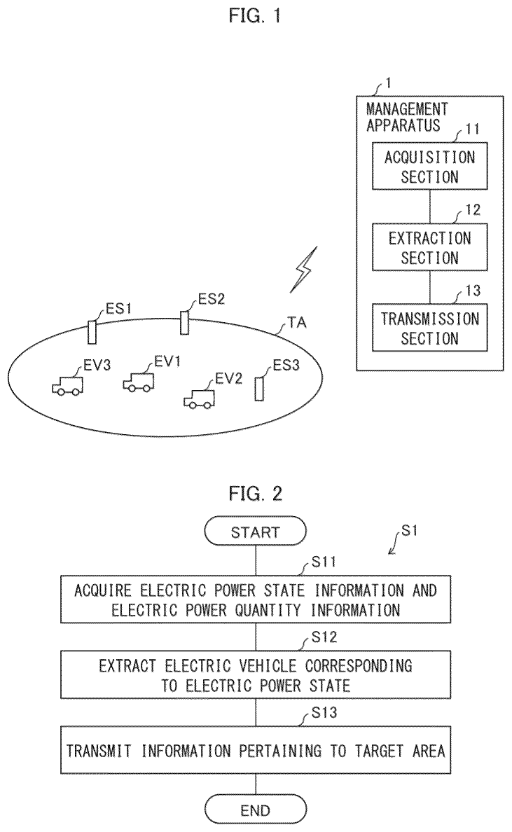

FIG. 1 is a diagram illustrating a configuration of a management apparatus according to a first example embodiment of the present invention together with exemplary charging facilities and electric vehicles. The management apparatus 1 according to the present example embodiment includes an acquisition section 11, extraction section 12, and a transmission section 13 as illustrated in FIG. 1. The management apparatus 1 can be constituted by, for example, a cloud platform or a server that is installed on the Internet. Alternatively, the management apparatus 1 may be a multi-access edge computing or mobile edge computing (MEC) server that is installed at a position close to a base station. The acquisition section 11 is configured to realize an acquisition means in the present example embodiment. The extraction section 12 is configured to realize an extraction means in the present example embodiment. The transmission section 13 is configured to realize a transmission means in the first example embodiment.

The acquisition section 11 acquires (i) electric power state information indicative of an electric power state in a target area TA including one or more charging facilities ES1 to ES3 and (ii) electric power quantity information indicative of an electric power quantity of each of a plurality of electric vehicles EV1 to EV3 capable of being subjected to charging and discharging in the target area TA.

The target area TA is set to include the one or more charging facilities ES1 to ES3. For example, a circular range of several km in radius around one charging facility may be set as the target area TA. Alternatively, a circular range of several km in radius around any point may be set as the target area TA. Further, the target area TA may be set to include a specific region.

The management apparatus 1 is capable of communicating, via a base station (not illustrated) installed in the target area TA or in a periphery outside the target area TA, with on-board terminals installed on the electric vehicles EV1 to EV3 in the target area TA. For example, the base station may be a 5th Generation Mobile Communication System (5G) base station installed by a telecommunications carrier, or may be a base station of a network called local 5G and operated by a person other than the telecommunication carrier. Alternatively, the base station may be a Wifi (registered trademark) base station or a 4th Generation Mobile Communication System (4G) base station. Further, a communication service provision area in the target area TA may be composed of a plurality of cells.

The charging facilities ES1 to ES3 are each a charging facility provided with a charging station, and can carry out electric power charging or discharging with respect to the electric vehicles EV1 to EV3. The electric vehicles EV1 to EV3 are each a vehicle such as an electric automobile, a plug-in hybrid vehicle, a turret truck, an electric microcar, an electric two-wheel vehicle, or a Segway. Generally, an electric vehicle that has an insufficient electric power quantity is subjected to charging (purchases electricity) in any of the charging facilities ES1 to ES3, and an electric vehicle that has a sufficient electric power quantity is subjected to discharging (sells electricity) in any of the charging facilities ES1 to ES3.

For example, the management apparatus 1 is configured to be capable of communicating, via a network, with an energy management system in which a smart grid is used. Note here that a specific configuration of the network is not limited to the present example embodiment. Examples of the network include a wireless local area network (LAN), a wired LAN, a wide area network (WAN), a public network, a mobile data communication network, and a combination of these networks.

For example, the acquisition section 11 can acquire, from an energy management system, electric power state information indicative of an electric power state of each of the charging facilities ES1 to ES3. Alternatively, the acquisition section 11 may be configured to acquire, from each of the charging facilities ES1 to ES3 via the above-described network, the electric power state information indicative of the electric power state. The electric power state information of a charging facility refers to, for example, a ratio of a value of a current quantity of supply of electricity of which the charging facility can give a charge (quantity of electric power that the charging facility is currently storing) to 100% of a maximum value of a quantity of supply of electricity of which the charging facility can give a charge (quantity of electric power that the charging facility can store).

Further, the acquisition section 11 acquires electric power quantity information indicative of an electric power quantity from each of the plurality of electric vehicles EV1 to EV3. Each of the on-board terminals installed on the electric vehicles EV1 to EV3 regularly transmits the electric power quantity information indicative of an electric power quantity of each of the electric vehicles EV1 to EV3 to the management apparatus 11. Alternatively, each of the on-board terminals may be configured to transmit, when requested by the management apparatus 1, the electric power quantity information indicative of the electric power quantity of each of the plurality of electric vehicles EV1 to EV3 to the management apparatus 11.

The extraction section 12 extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area.

For example, the extraction section 12 refers to the electric power quantity information of the electric vehicles EV1 to EV3 and extracts, as an electric vehicle corresponding to a charging facility which is among the charging facilities ES1 to ES3 and the electric power state of which is tough, an electric vehicle which has a sufficient electric power quantity and from which electricity can be discharged to a charging facility. Further, the extraction section 12 refers to the electric power quantity information of the electric vehicles EV1 to EV3 and extracts, as an electric vehicle corresponding to a charging facility that is among the charging facilities ES1 to ES3 and that is in an oversupply state in which the electric power state is stable, a vehicle that has an insufficient electric power quantity and that needs to be charged with electricity from a charging facility.

The transmission section 13 transmits information pertaining to the target area TA to at least one of the electric vehicles EV1 to EV3 that has been extracted by the extraction section 12. For example, the transmission section 13 transmits, to a vehicle which has a sufficient electric power quantity and from which electricity can be discharged to a charging facility, information pertaining to a charging facility which is among the charging facilities ES1 to ES3 in the target area TA and the electric power state of which is tough. Further, the transmission section 13 transmits, to a vehicle that has an insufficient electric power quantity and that needs to be charged with electricity from a charging facility, information pertaining to a charging facility that is among the charging facilities ES1 to ES3 in the target area TA and that is in an oversupply state in which the electric power state is stable.

(Effect Brought about by Management Apparatus According to First Example Embodiment)

As described above, according to the management apparatus 1 according to the present example embodiment, the extraction section 12 extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area. Thus, for example, the transmission section 13 transmits, to an electric vehicle which has a sufficient electric power quantity and from which electricity can be discharged to a charging facility, information pertaining to a charging facility which is among the charging facilities ES1 to ES3 in the target area TA and the electric power state of which is tough. This allows electricity to be charged (sold) from an electric vehicle which has a sufficient electric power quantity to a charging facility the electric power state of which is tough.

Further, the transmission section 13 transmits, to a vehicle that has an insufficient electric power quantity and that needs to be charged with electricity from a charging facility, information pertaining to a charging facility that is among the charging facilities ES1 to ES3 in the target area TA and that is in an oversupply state in which the electric power state is stable. This enables an electric vehicle which has an insufficient electric power quantity to be charged with electricity (purchase electricity) from a charging facility the electric power state of which is stable.

### <Management Method According to First Example Embodiment>

FIG. 2 is a flowchart showing a flow of a management method according to the first example embodiment of the present invention. As shown in FIG. 2, a management method S1 includes steps S11 to S13. First, the acquisition section 11 acquires (i) electric power state information indicative of an electric power state in a target area TA including one or more charging facilities ES1 to ES3 and (ii) electric power quantity information indicative of an electric power quantity of each of a plurality of electric vehicles EV1 to EV3 capable of being subjected to charging and discharging in the target area TA (S11).

Next, the extraction section 12 extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area TA (S12).

Lastly, the transmission section 13 transmits information pertaining to the target area TA to the extracted at least one of the electric vehicles EV1 to EV3 (S13). For example, the transmission section 13 transmits, to a vehicle which has a sufficient electric power quantity and from which electricity can be discharged to a charging facility, information pertaining to a charging facility which is among the charging facilities ES1 to ES3 in the target area TA and the electric power state of which is tough. Further, the transmission section 13 transmits, to a vehicle that has an insufficient electric power quantity and that needs to be charged with electricity from a charging facility, information pertaining to a charging facility that is among the charging facilities ES1 to ES3 in the target area TA and that is in an oversupply state in which the electric power state is stable.

(Effect Brought about by Management Method According to First Example Embodiment)

As described above, according to the management method according to the present example embodiment, for example, the transmission section 13 transmits, to an electric vehicle which has a sufficient electric power quantity and from which electricity can be discharged to a charging facility, information pertaining to a charging facility which is among the charging facilities ES1 to ES3 in the target area TA and the electric power state of which is tough. This allows electricity to be charged (sold) from an electric vehicle which has a sufficient electric power quantity to a charging facility the electric power state of which is tough.

Further, the transmission section 13 transmits, to a vehicle that has an insufficient electric power quantity and that needs to be charged with electricity from a charging facility, information pertaining to a charging facility that is among the charging facilities ES1 to ES3 in the target area TA and that is in an oversupply state in which the electric power state is stable. This enables an electric vehicle which has an insufficient electric power quantity to be charged with electricity (purchase electricity) from a charging facility the electric power state of which is stable.

### <Management System 100 According to First Example Embodiment>

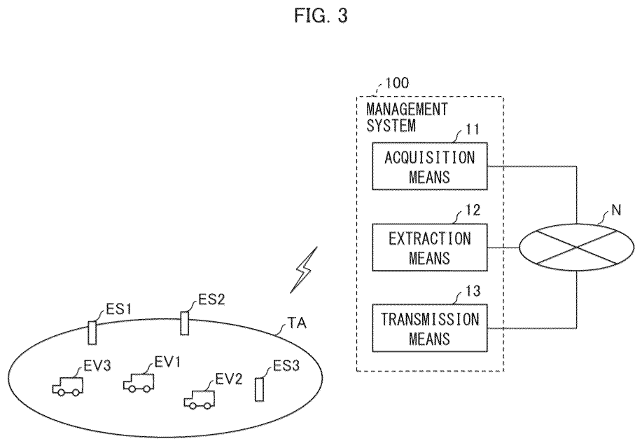

The management system 100 according to the present example embodiment includes an acquisition means 11, an extraction means 12, and a transmission means 13 as illustrated in FIG. 3. For example, the acquisition means 11, the extraction means 12, and the transmission means 13 are configured to be capable of communicating with each other via a network N. Note here that a specific configuration of the network N is not limited to the present example embodiment. Examples of the network N include a wireless LAN, a wired LAN, a WAN, a public network, a mobile data communication network, and a combination of these networks.

The acquisition means 11 acquires (i) electric power state information indicative of an electric power state in a target area TA including one or more charging facilities ES1 to ES3 and (ii) electric power quantity information indicative of an electric power quantity of each of a plurality of electric vehicles EV1 to EV3 capable of being subjected to charging and discharging in the target area TA.

For example, the acquisition means 11 can acquire, from an energy management system, electric power state information indicative of an electric power state of each of the charging facilities ES1 to ES3. Alternatively, the acquisition means 11 may be configured to acquire, from each of the charging facilities ES1 to ES3 via the above-described network, the electric power state information indicative of the electric power state. Further, the acquisition means 11 acquires electric power quantity information indicative of an electric power quantity from each of the plurality of electric vehicles EV1 to EV3.

The extraction means 12 extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area.

The transmission means 13 transmits information pertaining to the target area TA to at least one of the electric vehicles EV1 to EV3 that has been extracted by the extraction means 12. For example, the transmission means 13 transmits, to an electric vehicle which has a sufficient electric power quantity and from which electricity can be discharged to a charging facility, information pertaining to a charging facility which is among the charging facilities ES1 to ES3 in the target area TA and the electric power state of which is tough. Further, the transmission means 13 transmits, to an electric vehicle that has an insufficient electric power quantity and that needs to be charged with electricity from a charging g facility, information pertaining to a charging facility that is among the charging facilities ES1 to ES3 in the target area TA and that is in an oversupply state in which the electric power state is stable.

(Effect Brought about by Management System According to First Example Embodiment)

As described above, according to the management system 100 according to the present example embodiment, for example, the transmission means 13 transmits, to an electric vehicle which has a sufficient electric power quantity and from which electricity can be discharged to a charging facility, information pertaining to a charging facility which is among the charging facilities ES1 to ES3 in the target area TA and the electric power state of which is tough. This allows electricity to be charged (sold) from an electric vehicle which has a sufficient electric power quantity to a charging facility the electric power state of which is tough.

Further, the transmission means 13 transmits, to a vehicle that has an insufficient electric power quantity and that needs to be charged with electricity from a charging facility, information pertaining to a charging facility that is among the charging facilities ES1 to ES3 in the target area TA and that is in an oversupply state in which the electric power state is stable. This enables an electric vehicle which has an insufficient electric power quantity to be charged with electricity (purchase electricity) from a charging facility the electric power state of which is stable.

### Second Example Embodiment

The following description will discuss a second example embodiment of the present invention in detail with reference to the drawings. Note that members having functions identical to those of the respective members described in the first example embodiment are given respective identical reference numerals, and a description of those members is omitted as appropriate.

### <Information Processing Apparatus 1A According to Second Example Embodiment>

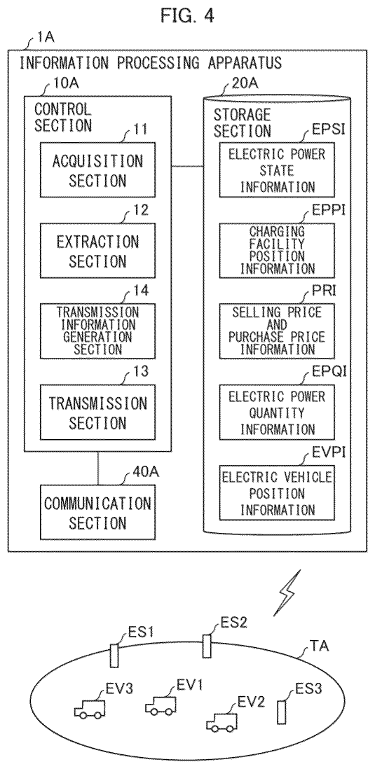

FIG. 4 is a diagram illustrating a configuration of an information processing apparatus 1A according to a second example embodiment of the present invention together with exemplary charging facilities and electric vehicles. The information processing apparatus 1A according to the present example embodiment includes a control section 10A, a storage section 20A, and a communication section 40A as illustrated in FIG. 4.

The communication section 40A is capable of communicating, via a base station (not illustrated) installed in a target area TA or in a periphery outside the target area TA, with on-board terminals installed on electric vehicles EV1 to EV3 and charging facilities ES1 to ES3 in the target area TA. For example, the base station may be a 5th Generation Mobile Communication System (5G) base station installed by a telecommunications carrier, or may be a base station of a network called local 5G and operated by a person other than the telecommunication carrier. Alternatively, the base station may be a Wifi (registered trademark) base station or a 4th Generation Mobile Communication System (4G) base station. Further, a communication service provision area in the target area TA may be composed of a plurality of cells.

The control section 10A includes an acquisition section 11, an extraction section 12, a transmission section 13, and a transmission information generation section 14. Note that members having functions identical to those of the respective members described in the first example embodiment are given respective identical reference numerals, and a description of those members is omitted as appropriate.

The acquisition section 11 acquires, via the communication section 40A, (i) electric power state information indicative of an electric power state in a target area TA including one or more charging facilities ES1 to ES3 and (ii) electric power quantity information indicative of an electric power quantity of each of a plurality of electric vehicles EV1 to EV3 capable of being subjected to charging and discharging in the target area TA.

The extraction section 12 extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area.

The transmission information generation section 14 generates, for example, information pertaining to the target area TA from, for example, (i) the electric power state information indicative of an electric power state of the one or more charging facilities ES1 to ES3 included in the target area TA and (ii) the electric power quantity information indicative of the electric power quantity of each of the plurality of electric vehicles EV1 to EV3 capable of being subjected to charging and discharging in the target area TA.

The storage section 20A is constituted by, for example, a random access memory (RAM) including a battery, a flash memory serving as a nonvolatile memory, or a hard disk. The storage section 20A preferably holds information when a power supply of the information processing apparatus 1A is turned off. Note, however, that the storage section 20A may store such information in a hard disk or the like of the information processing apparatus 1A and transfer the information from the hard disk or the like to the storage section 20A during start of the information processing apparatus 1A, the storage section 20A being constituted by a volatile RAM.

The storage section 20A stores electric power state information EPSI, charging facility position information EPPI, selling price and purchase price information PRI, electric power quantity information EPQI, and electric vehicle position information EVPI. The electric power state information EPSI is information indicative of an electric power state of each of the one or more charging facilities ES1 to ES3 included in the target area TA.

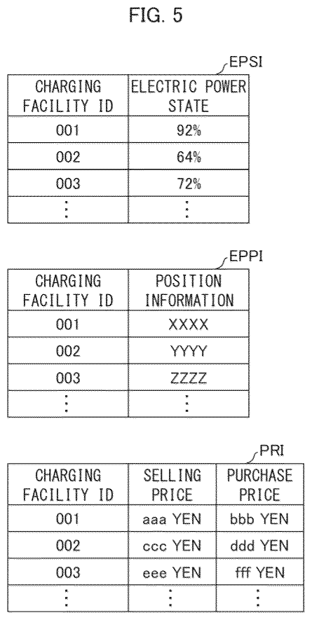

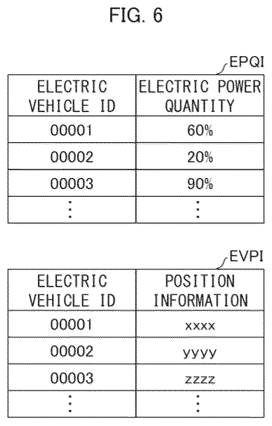

FIG. 5 is a diagram illustrating an example of the electric power state information EPSI, the charging facility position information EPPI, and the selling price and purchase price information PRI that are stored in the storage section 20A of the information processing apparatus 1A. FIG. 6 is a diagram illustrating an example of the electric power quantity information EPQI and the electric vehicle position information EVPI that are stored in the storage section 20A of the information processing apparatus 1A. Note that charging facilities having charging facility IDs “001” to “003” correspond to the respective charging facilities ES1 to ES3. Note also that electric vehicles having electric vehicle IDs “00001” to “00003” correspond to the respective electric vehicles EV1 to EV3.

As shown in an upper diagram of FIG. 5, it is indicated, for example, that respective pieces of the electric power state information EPSI of the charging facilities having the charging facility IDs “001” to “003” are “92%”, “64%”, and “72%”. The acquisition section 11 receives as appropriate, from an energy management system via the communication section 40A, the electric power state information indicative of the electric power state of each of the charging facilities ES1 to ES3, and updates the electric power state information EPSI stored in the storage section 20A. Alternatively, the acquisition section 11 may receive as appropriate, from each of the charging facilities ES1 to ES3 via the communication section 40A, the electric power state information indicative of the electric power state, and update the electric power state information EPSI stored in the storage section 20A.

The charging facility position information EPPI is information indicative of a position of each of the one or more charging facilities ES1 to ES3 included in the target area TA. As shown in a middle diagram of FIG. 5, it is indicated, for example, that respective pieces of the position information of the charging facilities having the charging facility IDs “001” to “003” are “XXXX”, “YYYY”, and “ZZZZ”. Since the charging facility position information EPPI stored in the storage section 20A is fixed, the charging facility position information EPPI is assumed to be registered in advance. Note that the charging facility position information EPPI stored in the storage section 20A is added or deleted as appropriate in a case a charging facility is newly established or removed.

The selling price and purchase price information PRI is information indicative of a selling price and a purchase price of electric power of each of the one or more charging facilities ES1 to ES3 included in the target area TA. As shown in a lower diagram of FIG. 5, it is indicated, for example, that respective pieces of the selling price and purchase price information PRI of the charging facilities having the charging facility IDs “001” to “003” are “selling price: aaa yen, purchase price: bbb yen”, “selling price: ccc yen, purchase price: ddd yen”, and “selling price: eee yen, purchase price: fff yen”. The acquisition section 11 receives the selling price and purchase price information PRI as appropriate from each of the charging facilities ES1 to ES3 via the communication section 40A, and updates the selling price and purchase price information PRI stored in the storage section 20A.

The electric power quantity information EPQI is information indicative of an electric power quantity of each of the plurality of electric vehicles EV1 to EV3 capable of being subjected to charging and discharging in the target area TA. As shown in an upper diagram of FIG. 6, it is indicated, for example, that respective pieces of the electric power quantity information EPQI of the electric vehicles having the electric vehicle IDs “00001” to “00003” are “60%”, “20%”, and “90%”. The acquisition section 11 receives as appropriate, from each of the electric vehicles EV1 to EV3 via the communication section 40A, the electric power quantity information indicative of the electric power quantity, and updates the electric power quantity information EPQI stored in the storage section 20A.

The electric vehicle position information EVPI is information indicative of a position of each of the plurality of electric vehicles EV1 to EV3 capable of being subjected to charging and discharging in the target area TA. As shown in a lower diagram of FIG. 6, it is indicated, for example, that respective pieces of the electric vehicle position information EVPI of the electric vehicles having the electric vehicle IDs “00001” to “00003” are “xxxx”, “yyyy”, and “zzzz”. The acquisition section 11 receives as appropriate, from each of the electric vehicles EV1 to EV3 via the communication section 40A, the electric vehicle position information indicative of a position of an electric vehicle, and updates the electric vehicle position information EVPI stored in the storage section 20A.

Note here that, for example, the electric vehicle position information of each of the electric vehicles EV1 to EV3 can be acquired by a global positioning system (GPS) apparatus installed on each of the electric vehicles EV1 to EV3. The electric vehicles EV1 to EV3 each transmit, to the information processing apparatus 1A as appropriate, the electric vehicle position information acquired by the GPS apparatus.

(Case where Electric Power State of Charging Facility Indicates Oversupply of Electric Power)

In a case where the electric power state of a charging facility indicates an oversupply of electric power, the extraction section 12 extracts at least one electric vehicle which is among the plurality of electric vehicles EV1 to EV3 and the electric power quantity of which is not more than a first threshold. For example, the first threshold is a value of approximately 20%, but is not particularly limited to this value.

For example, the extraction section 12 refers to the electric power quantity information EPQI (shown in the upper diagram of FIG. 6) of the electric vehicles EV1 to EV3, and extracts, as a vehicle that has an insufficient electric power quantity and that needs to be charged with electricity from a charging facility, the electric vehicle EV2 the electric power quantity information EPQI of which is “20%”. Further, the extraction section 12 refers to the electric power state information EPSI shown in the upper diagram of FIG. 5, and extracts, as a charging facility the electric power state of which indicates an oversupply of electric power, a charging facility that is the charging facility ES1 the electric power state of which is relatively high “92%”.

The transmission information generation section 14 generates, as the information pertaining to the target area TA, information pertaining to the charging facility ES1 extracted by the extraction section 12 as the charging facility the electric power state of which indicates an oversupply of electric power.

The information pertaining to the target area TA includes position information of the one or more charging facilities ES1 to ES3 in the target area TA. The transmission information generation section 14 includes the position information of the charging facility ES1 as transmission information that is to be transmitted to the electric vehicle EV2 which has been extracted by the extraction section 12. The transmission section 13 transmits the position information of the charging facility ES1 to the electric vehicle EV2 via the communication section 40A.

Further, the information pertaining to the target area may include information pertaining to at least one of a selling price and a purchase price of electric power in each of the one or more charging facilities ES1 to ES3 in the target area TA. For example, the transmission information generation section 14 includes the selling price and purchase price information PRI of the charging facility ES1 as the transmission information that is to be transmitted to the electric vehicle EV2 which has been extracted by the extraction section 12. The transmission section 13 transmits the selling price and purchase price information of the charging facility ES1 to the electric vehicle EV2 via the communication section 40A.

Furthermore, the information pertaining to the target area may include information indicating that charging is recommended in the one or more charging facilities ES1 to ES3 in the target area TA. For example, the transmission information generation section 14 includes, as the transmission information that is to be transmitted to the electric vehicle EV2 which has been extracted by the extraction section 12, information indicating that charging is recommended in the charging facility ES1. The transmission section 13 transmits, to the electric vehicle EV2 via the communication section 40A, the information indicating that charging is recommended in the charging facility ES1.

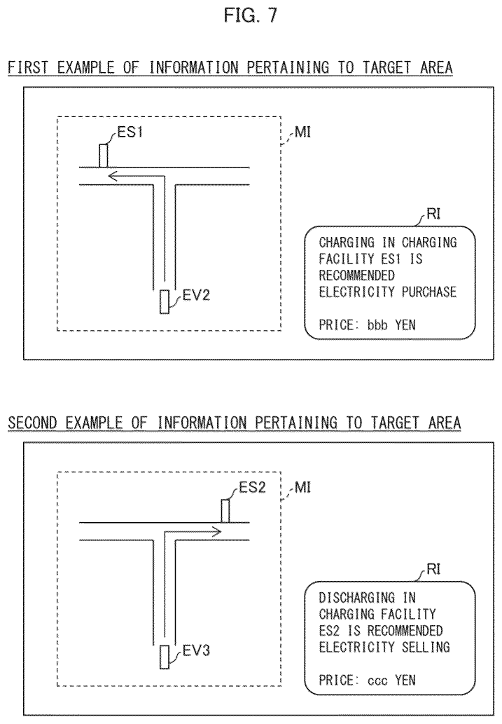

FIG. 7 is a diagram illustrating an example of information pertaining to a target area. For example, a car navigation system is installed on each of the electric vehicles EV1 to EV3. It is possible to display, on the car navigation system, route information and recommendation information together with map information. An upper diagram of FIG. 7 illustrates an example of a display screen of a display apparatus of a car navigation system. The display apparatus provides the electric vehicle EV2 with a display of (i) route information MI to the charging facility ES1 and (ii) recommendation information RI indicating that charging is recommended in the charging facility ES1. Further, the display apparatus displays, as the recommendation information RI, an electricity purchase price “bbb yen” in the charging facility ES1.

(Case where Electric Power State of Charging Facility Indicates Electric Power Shortage)

In a case where the electric power state of a charging facility indicates an electric power shortage, the extraction section 12 extracts at least one electric vehicle which is among the plurality of electric vehicles EV1 to EV3 and the electric power quantity of which is not less than a second threshold. For example, the second threshold is a value of approximately 80%, but is not particularly limited to this value.

For example, the extraction section 12 refers to the electric power quantity information EPQI (shown in the upper diagram of FIG. 6) of the electric vehicles EV1 to EV3, and extracts, as a vehicle which has a sufficient electric power quantity and from which electricity can be discharged to a charging facility, the electric vehicle EV3 the electric power quantity information EPQI of which is “90%”. Further, the extraction section 12 refers to the electric power state information EPSI shown in the upper diagram of FIG. 5, and extracts, as a charging facility the electric power state of which indicates an electric power shortage, a charging facility that is the charging facility ES2 the electric power state of which is relatively low “64%”.

The transmission information generation section 14 generates, as the information pertaining to the target area TA, information pertaining to the charging facility ES2 extracted by the extraction section 12 as the charging facility the electric power state of which indicates an electric power shortage.

The transmission information generation section 14 includes the position information of the charging facility ES2 as transmission information that has been extracted by the extraction section 12 and that is to be transmitted to the electric vehicle EV3. The transmission section 13 transmits the position information of the charging facility ES2 to the electric vehicle EV3 via the communication section 40A.

Further, the transmission information generation section 14 includes the selling price and purchase price information PRI of the charging facility ES2 as the transmission information that has been extracted by the extraction section 12 and that is to be transmitted to the electric vehicle EV3. The transmission section 13 transmits the selling price and purchase price information of the charging facility ES2 to the electric vehicle EV3 via the communication section 40A.

Furthermore, the information pertaining to the target area may include information indicating that discharging is recommended in the one or more charging facilities ES1 to ES3 in the target area. For example, the transmission information generation section 14 includes, as the transmission information that has been extracted by the extraction section 12 and that is to be transmitted to the electric vehicle EV3, information indicating that discharging is recommended in the charging facility ES2. The transmission section 13 transmits, to the electric vehicle EV3 via the communication section 40A, the information indicating that discharging is recommended in the charging facility ES2.

A lower diagram of FIG. 7 illustrates an example of a display screen of a display apparatus of a car navigation system. The display apparatus provides the electric vehicle EV3 with a display of (i) the route information MI to the charging facility ES2 and (ii) the recommendation information RI indicating that discharging is recommended in the charging facility ES2. Further, the display apparatus displays, as the recommendation information RI, an electricity selling price of “ccc yen” in the charging facility ES2.

(Effect Brought about by Information Processing Apparatus 1A According to Second Example Embodiment)

As described above, according to the information processing apparatus 1A according to the present example embodiment, the transmission section 13 transmits the information pertaining to the target area TA, the information including position information of the one or more charging facilities ES1 to ES3 in the target area TA. For example, a display apparatus of the car navigation system installed on each of the electric vehicles EV1 to EV3 can display route information to a charging facility. This makes it possible to increase user convenience.

Further, the transmission section 13 transmits the information pertaining to the target area TA, the information including information pertaining to at least one of a selling price and a purchase price of electric power in each of the one or more charging facilities ES1 to ES3 in the target area TA. For example, a display apparatus of the car navigation system installed on each of the electric vehicles EV1 to EV3 can display at least one of a selling price and a purchase price of electric power in a charging facility. This makes it possible to provide a material for determination which material is used by a user to determine selling of electricity or purchasing of electricity.

Furthermore in a case where the electric power state of a charging facility indicates an oversupply of electric power, the extraction section 12 extracts at least one electric vehicle which is among the plurality of electric vehicles EV1 to EV3 and the electric power quantity of which is not more than a first threshold. Thus, it is possible to easily extract an electric vehicle corresponding to an electric power state of a charging facility.

Further, the transmission section 13 transmits the information pertaining to the target area TA, the information including information indicating that charging is recommended in the one or more charging facilities ES1 to ES3 in the target area TA. For example, a display apparatus of the car navigation system installed on each of the electric vehicles EV1 to EV3 can display information indicating that charging is recommended in the one or more charging facilities ES1 to ES3. This makes it possible to promote a user to purchase electricity.

Furthermore, in a case where the electric power state of a charging facility indicates an electric power shortage, the extraction section 12 extracts at least one electric vehicle which is among the plurality of electric vehicles EV1 to EV3 and the electric power quantity of which is not less than a second threshold. Thus, it is possible to easily extract an electric vehicle corresponding to an electric power state of a charging facility.

Further, the transmission section 13 transmits the information pertaining to the target area TA, the information including information indicating that discharging is recommended in the one or more charging facilities ES1 to ES3 in the target area. For example, a display apparatus of the car navigation system installed on each of the electric vehicles EV1 to EV3 can display information indicating that discharging is recommended in the one or more charging facilities ES1 to ES3. This makes it possible to promote a user to sell electricity.

### Third Example Embodiment

The following description will discuss a third example embodiment of the present invention in detail with reference to the drawings. Note that members having functions identical to those of the respective members described in the first and second example embodiments are given respective identical reference numerals, and a description of those members is omitted as appropriate.

### <Information Processing Apparatus 1B According to Third Example Embodiment>

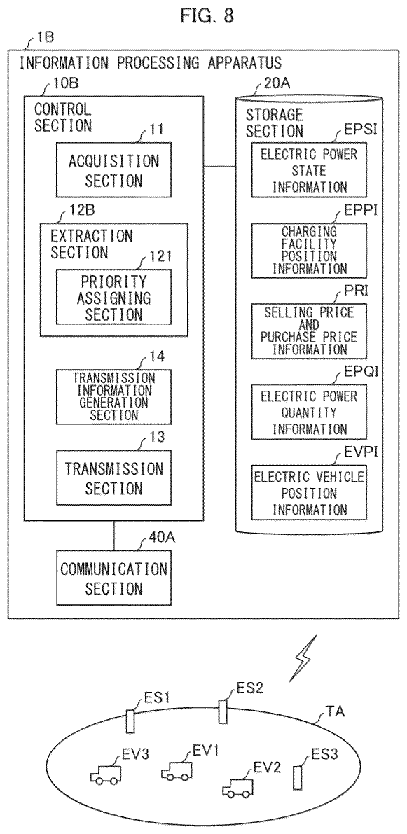

FIG. 8 is a diagram illustrating a configuration of an information processing apparatus 1B according to a third example embodiment of the present invention together with exemplary charging facilities and electric vehicles. The information processing apparatus 1B according to the present example embodiment includes a control section 10B, a storage section 20A, and a communication section 40A as illustrated in FIG. 8.

The control section 10B includes an acquisition section 11, an extraction section 12B, a transmission section 13, and a transmission information generation section 14. Note that members having functions identical to those of the respective members described in the first and second example embodiments are given respective identical reference numerals, and a description of those members is omitted as appropriate.

The acquisition section 11 acquires, via the communication section 40A, (i) electric power state information indicative of an electric power state in a target area TA including one or more charging facilities ES1 to ES3 and (ii) electric power quantity information indicative of an electric power quantity of each of a plurality of electric vehicles EV1 to EV3 capable of being subjected to charging and discharging in the target area TA.

The extraction section 12B extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area.

The extraction section 12B includes a priority assigning section 121. In a case where the extraction section 12B extracts a plurality of electric vehicles EV1 to EV3, the priority assigning section 121 assigns priorities of the respective extracted electric vehicles EV1 to EV3.

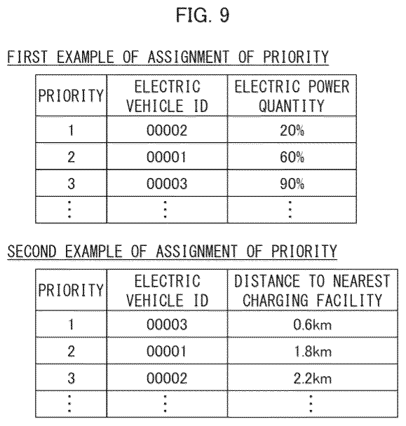

FIG. 9 is a diagram illustrating examples of priorities assigned by the priority assigning section 121. The priority assigning section 121 of the extraction section 12B assigns priorities to the respective plurality of electric vehicles EV1 to EV3 in accordance with an electricity quantity of each of the plurality of electric vehicles EV1 to EV3. Assume, for example, that the extraction section 12B refers to the electric power quantity information EPQI (shown in the upper diagram of FIG. 6) of the electric vehicles EV1 to EV3, and extracts a vehicle that has an insufficient electric power quantity and that needs to be charged with electricity from a charging facility. In this case, as shown in an upper diagram of FIG. 9, the priority assigning section 121 assigns higher priorities in ascending order of electric power quantity. In the upper diagram of FIG. 9, a highest priority “1” is assigned to the electric vehicle EV2 that has a smallest electric power quantity, and priorities “2” and “3” are assigned to the respective electric vehicles EV1 and EV3.

Assume, conversely, that the extraction section 12B extracts an electric vehicle which has a sufficient electric power quantity and from which electricity can be discharged to a charging facility. In this case, the priority assigning section 121 assigns higher priorities in descending order of electric power quantity.

The transmission information generation section 14 generates, as the information pertaining to the target area TA, information pertaining to the charging facility ES1 extracted by the extraction section 12B as the charging facility the electric power state of which indicates an oversupply of electric power.

The transmission section 13 transmits the information pertaining to the target area TA to an electric vehicle that has a relatively high priority. Assume, for example, that the information pertaining to the target area TA is set to be transmitted to two electric vehicles which have relatively high priorities. In this case, with reference to the priorities shown in the upper diagram of FIG. 9, the transmission section 13 transmits the information pertaining to the target area TA to the two electric vehicles EV1 and EV2 which have relatively high priorities.

Further, the priority assigning section 121 of the extraction section 12B may be configured to assign a relatively high priority to an electric vehicle that is among the plurality of electric vehicles and that is at a relatively short distance from at least one of the charging facilities ES1 to ES3. For example, as shown in a lower diagram of FIG. 9, the priority assigning section 121 assigns the priorities in accordance with a distance from each of the electric vehicles EV1 to EV3 to a corresponding nearest power receiving facility. In the lower diagram of FIG. 9, the highest priority “1” is assigned to the electric vehicle EV3 that has a smallest distance to the nearest charging facility, and the priorities “2” and “3” are assigned to the respective electric vehicles EV1 and EV2.

Assume, for example, that the information pertaining to the target area TA is set to be transmitted to two electric vehicles which have relatively high priorities. In this case, with reference to the priorities shown in the lower diagram of FIG. 9, the transmission section 13 transmits the information pertaining to the target area TA to the two electric vehicles EV3 and EV1 which have relatively high priorities.

(Effect Brought about by Information Processing Apparatus 1B According to Third Example Embodiment)

As described above, according to the information processing apparatus 1B according to the present example embodiment, in a case where the extraction section 12B extracts a plurality of electric vehicles EV1 to EV3, the priority assigning section 121 assigns priorities of the respective extracted electric vehicles EV1 to EV3. This enables the transmission section 13 to transmit the information pertaining to the target area TA to an electric vehicle that has a relatively high priority. This makes it possible to transmit the information to a user that is relatively high in need of the information pertaining to the target area TA.

Further, the priority assigning section 121 of the extraction section 12B assigns priorities to the respective plurality of electric vehicles EV1 to EV3 in accordance with an electricity quantity of each of the plurality of electric vehicles EV1 to EV3. This makes it possible to, for example, increase a priority of an electric vehicle that has an insufficient electric power quantity and that needs to be charged with electricity from a charging facility. Conversely, the priority assigning section 121 can also increase a priority of an electric vehicle which has a sufficient electric power quantity and from which electricity can be discharged to a charging facility.

Furthermore, the priority assigning section 121 of the extraction section 12B assigns a relatively high priority to an electric vehicle that is among the plurality of electric vehicles EV1 to EV3 and that is at a relatively short distance from at least one of the charging facilities ES1 to ES3. This enables the transmission section 13 to transmit the information pertaining to the target area TA preferentially to an electric vehicle that is close to a charging facility.

### Fourth Example Embodiment

The following description will discuss a fourth example embodiment of the present invention in detail with reference to the drawings. Note that members having functions identical to those of the respective members described in the first to third example embodiments are given respective identical reference numerals, and a description of those members is omitted as appropriate.

### <Information Processing Apparatus 1C According to Fourth Example Embodiment>

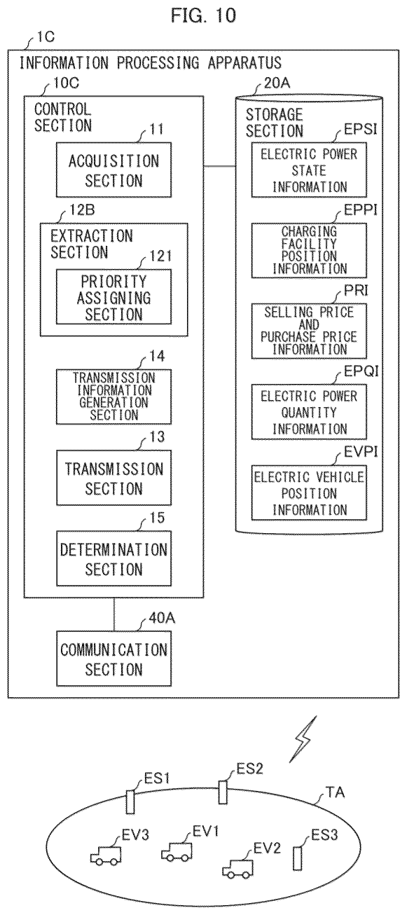

FIG. 10 is a diagram illustrating a configuration of an information processing apparatus 1C according to a fourth example embodiment of the present invention together with exemplary charging facilities and electric vehicles. The information processing apparatus 1C according to the present example embodiment includes a control section 10C, a storage section 20A, and a communication section 40A as illustrated in FIG. 10.

The control section 10C includes an acquisition section 11, an extraction section 12B, a transmission section 13, a transmission information generation section 14, and a determination section 15. Note that members having functions identical to those of the respective members described in the first to third example embodiments are given respective identical reference numerals, and a description of those members is omitted as appropriate.

The acquisition section 11 acquires, via the communication section 40A, (i) electric power state information indicative of an electric power state in a target area TA including one or more charging facilities ES1 to ES3 and (ii) electric power quantity information indicative of an electric power quantity of each of a plurality of electric vehicles EV1 to EV3 capable of being subjected to charging and discharging in the target area TA.

The extraction section 12B extracts, on the basis of the electric power quantity of each of the plurality of electric vehicles EV1 to EV3, the electric power quantity being indicated by the electric power quantity information, at least one of the electric vehicles EV1 to EV3 that is among the plurality of electric vehicles EV1 to EV3 and that corresponds to the electric power state in the target area. In a case where the extraction section 12B extracts a plurality of electric vehicles EV1 to EV3, the priority assigning section 121 assigns priorities of the respective extracted electric vehicles EV1 to EV3.

The transmission information generation section 14 generates, for example, information pertaining to the target area TA from, for example, (i) the electric power state information indicative of an electric power state of the one or more charging facilities ES1 to ES3 included in the target area TA and (ii) the electric power quantity information indicative of the electric power quantity of each of the plurality of electric vehicles EV1 to EV3 capable of being subjected to charging and discharging in the target area TA. The transmission section 13 transmits, to an electric vehicle that has a relatively high priority, the information pertaining to the target area TA, the information having been generated by the transmission information generation section 14.

The determination section 15 determines that any of the plurality of electric vehicles EV1 to EV3 has been subjected to charging and discharging. More specifically, the determination section 15 determines, with reference to (i) position information pertaining to each of the plurality of electric vehicles EV1 to EV3 and (ii) position information of the one or more charging facilities ES1 to ES3 in the target area TA, that any of the plurality of electric vehicles EV1 to EV3 has been subjected to charging and discharging.

For example, the determination section 15 acquires, from the storage section 20A, (i) electric vehicle position information EVPI of the electric vehicle EV2 illustrated in the upper diagram of FIG. 7 and recommended to be subjected to charging and (ii) charging facility position information EPPI of the recommended charging facility ES1 illustrated in the upper diagram of FIG. 7. In a case where the electric vehicle EV2 remains in the charging facility ES1 for not less than a predetermined length of time, the determination section 15 determines that the electric vehicle EV2 has been subjected to charging in the charging facility ES1. Also in a case where the electric vehicle EV2 remains in an unrecommended charging facility for not less than a predetermined length of time, the determination section 15 may be configured to determine that the electric vehicle EV2 has been subjected to charging in the unrecommended charging facility.

Similarly, the determination section 15 acquires, from the storage section 20A, (i) the electric vehicle position information EVPI of the electric vehicle EV3 illustrated in the lower diagram of FIG. 7 and recommended to be subjected to discharging and (ii) the charging facility position information EPPI of the recommended charging facility ES2 illustrated in the lower diagram of FIG. 7. In a case where the electric vehicle EV3 remains in the charging facility ES2 for not less than a predetermined length of time, the determination section 15 determines that the electric vehicle EV3 has been subjected to discharging in the charging facility ES1.

The transmission section 13 transmits, in accordance with a determination result from the determination section 15, the information pertaining to the target area TA also to an electric vehicle that has a relatively low priority. In a case where an electric vehicle that has a relatively high priority and that has received the information pertaining to the target area TA purchases electricity or sells electricity, the electric vehicle has a lower priority. Thus, the transmission section 13 excludes the electric vehicle and transmits the information pertaining to the target area TA also to an electric vehicle that has a relatively low priority.

Further, the determination section 15 may determine, with reference to information which has been acquired from at least one of the plurality of electric vehicles EV1 to EV3 and which indicates that the at least one of the plurality of electric vehicles EV1 to EV3 has been subjected to charging and discharging, that the at least one of the plurality of electric vehicles EV1 to EV3 has been subjected to charging and discharging. In this case, when charging and discharging of a corresponding one of the plurality of electric vehicles EV1 to EV3 is completed, an on-board terminal installed on each of the electric vehicles EV1 to EV3 transmits, to the information processing apparatus 1C, information indicating that charging and discharging have been carried out. When the information processing apparatus 1C receives, via the communication section 40A, the information indicating that charging and discharging have been carried out, the determination section 15 determines that the electric vehicle has been subjected to charging and discharging.

(Effect Brought about by Information Processing Apparatus 1C According to Fourth Example Embodiment)

As described above, according to the information processing apparatus 1C according to the present example embodiment, the transmission section 13 transmits, in accordance with a determination result from the determination section 15, the information pertaining to the target area TA also to an electric vehicle that has a relatively low priority. Thus, in a case where an electric vehicle that has a relatively high priority and that has received the information pertaining to the target area TA purchases electricity or sells electricity, the transmission section 13 can exclude the electric vehicle and transmit the information pertaining to the target area TA also to an electric vehicle that has a relatively low priority.

Further, the determination section 15 determines, with reference to (i) position information pertaining to each of the plurality of electric vehicles EV1 to EV3 and (ii) position information of the one or more charging facilities ES1 to ES3 in the target area TA, that any of the plurality of electric vehicles EV1 to EV3 has been subjected to charging and discharging. This enables the determination section 15 to easily determine that any of the plurality of electric vehicles EV1 to EV3 has been subjected to charging and discharging.

Furthermore, the determination section 15 determines, with reference to information which has been acquired from at least one of the plurality of electric vehicles EV1 to EV3 and which indicates that the at least one of the plurality of electric vehicles EV1 to EV3 has been subjected to charging and discharging, that the at least one of the plurality of electric vehicles EV1 to EV3 has been subjected to charging and discharging. This enables the determination section 15 to easily determine that any of the plurality of electric vehicles EV1 to EV3 has been subjected to charging and discharging.

### [Software Implementation Example]

A part or all of the functions of each of the management apparatus 1, the information processing apparatuses 1A to 1C, and the management system 100 may be realized by hardware such as an integrated circuit (IC chip) or may be alternatively realized by software.

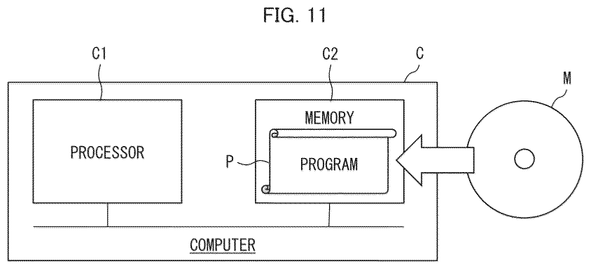

In the latter case, the management apparatus 1, the information processing apparatuses 1A to 1C, and the management system 100 are each realized by, for example, a computer that executes instructions of a program that is software realizing the functions. FIG. 11 illustrates an example of such a computer (hereinafter referred to as “computer C”). The computer C includes at least one processor C1 and at least one memory C2. The memory C2 stores a program P for causing the computer C to operate as the management apparatus 1, the information processing apparatuses 1A to 1C, and the management system 100. In the computer C, the functions of each of the management apparatus 1, the information processing apparatuses 1A to 1C, and the management system 100 are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a RAM in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

A management apparatus including:
an acquisition means for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
an extraction means for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
a transmission means for transmitting information pertaining to the target area to at least one of the at least one electric vehicle extracted by the extraction means.

The above configuration allows electricity to be charged (sold) from an electric vehicle which has a sufficient electric power quantity to a charging facility the electric power state of which is tough. Further, an electric vehicle which has an insufficient electric power quantity can be charged with electricity (purchase electricity) from a charging facility the electric power state of which is stable.

### (Supplementary Note 2)

The management apparatus according to Supplementary note 1, wherein
the information pertaining to the target area includes position information of the one or more charging facilities in the target area.

According to the above configuration, for example, a display apparatus of a car navigation system installed on an electric vehicle can display route information to a charging facility. This makes it possible to increase user convenience.

### (Supplementary Note 3)

The management apparatus according to Supplementary note 1 or 2, wherein
the information pertaining to the target area includes information pertaining to at least one of a selling price and a purchase price of electric power in each of the one or more charging facilities in the target area.

According to the above configuration, for example, a display apparatus of a car navigation system installed on an electric vehicle can display at least one of a selling price and a purchase price of electric power in a charging facility. This makes it possible to provide a material for determination which material is used by a user to determine selling of electricity or purchasing of electricity.

### (Supplementary Note 4)

The management apparatus according to any one of Supplementary notes 1 to 3, wherein
in a case where the electric power state indicates an oversupply of electric power, the extraction means extracts the at least one electric vehicle which is among the plurality of electric vehicles and the electric power quantity of which is not more than a first threshold.

The above configuration makes it possible to easily extract an electric vehicle corresponding to an electric power state of a charging facility.

### (Supplementary Note 5)

The management apparatus according to Supplementary note 4, wherein
the information pertaining to the target area includes information indicating that charging is recommended in the one or more charging facilities in the target area.

According to the above configuration, for example, a display apparatus of a car navigation system installed on an electric vehicle can display information indicating that charging is recommended in a charging facility. This makes it possible to promote a user to purchase electricity.

### (Supplementary Note 6)

The management apparatus according to any one of Supplementary notes 1 to 3, wherein
in a case where the electric power state indicates an electric power shortage, the extraction means extracts the at least one electric vehicle which is among the plurality of electric vehicles and the electric power quantity of which is not less than a second threshold.

The above configuration makes it possible to easily extract an electric vehicle corresponding to an electric power state of a charging facility.

### (Supplementary Note 7)

The management apparatus according to Supplementary note 6, wherein
the information pertaining to the target area includes information indicating that discharging is recommended in the one or more charging facilities in the target area.

According to the above configuration, for example, a display apparatus of a car navigation system installed on an electric vehicle can display information indicating that discharging is recommended in a charging facility. This makes it possible to promote a user to sell electricity.

### (Supplementary Note 8)

The management apparatus according to any one of Supplementary notes 4 to 7, wherein
in a case where the extracted at least one electric vehicle comprises a plurality of electric vehicles,
the extraction means
   assigns priorities of the respective extracted plurality of electric vehicles, and
   transmits the information pertaining to the target area to an electric vehicle that has a relatively high priority.

The above configuration enables the transmission means to transmit the information pertaining to the target area to an electric vehicle that has a relatively high priority. This makes it possible to transmit the information to a user that is relatively high in need of the information pertaining to the target area.

### (Supplementary Note 9)

The management apparatus according to Supplementary note 8, wherein
the extraction means assigns the priorities to the respective plurality of electric vehicles in accordance with an electricity quantity of each of the plurality of electric vehicles.

The above configuration enables the extraction means to increase a priority of an electric vehicle that has an insufficient electric power quantity and that needs to be charged with electricity from a charging facility. Further, the extraction means can also increase a priority of an electric vehicle which has a sufficient electric power quantity and from which electricity can be discharged to a charging facility.

### (Supplementary Note 10)

The management apparatus according to Supplementary note 8, wherein
the extraction means assigns a relatively high priority to an electric vehicle that is among the plurality of electric vehicles and that is at a relatively short distance from at least one of the one or more charging facilities.

The above configuration enables the transmission means to transmit the information pertaining to the target area TA preferentially to an electric vehicle that is close to a charging facility.

### (Supplementary Note 11)

The management apparatus according to any one of Supplementary notes 8 to 10, further including
a determination means for determining that any of the plurality of electric vehicles has been subjected to charging and discharging,
the transmission means transmitting, in accordance with a determination result from the determination means, the information pertaining to the target area also to an electric vehicle that has a relatively low priority.

According to the above configuration, in a case where an electric vehicle that has a relatively high priority and that has received the information pertaining to the target area purchases electricity or sells electricity, it is possible to exclude the electric vehicle and transmit the information pertaining to the target area also to an electric vehicle that has a relatively low priority.

### (Supplementary Note 12)

The management apparatus according to Supplementary note 11, wherein
the determination means determines, with reference to (i) position information pertaining to each of the plurality of electric vehicles and (ii) position information of the one or more charging facilities in the target area, that any of the plurality of electric vehicles has been subjected to charging and discharging.

The above configuration enables the determination means to easily determine that any of the plurality of electric vehicles has been subjected to charging and discharging.

### (Supplementary Note 13)

The management apparatus according to Supplementary note 11, wherein
the determination means determines, with reference to information which has been acquired from at least one of the plurality of electric vehicles and which indicates that the at least one of the plurality of electric vehicles has been subjected to charging and discharging, that the at least one of the plurality of electric vehicles has been subjected to charging and discharging.

The above configuration enables the determination means to easily determine that any of the plurality of electric vehicles has been subjected to charging and discharging.

### (Supplementary Note 14)

A management system including:
an acquisition means for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
an extraction means for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
a transmission means for transmitting information pertaining to the target area to at least one of the at least one electric vehicle extracted by the extraction means.

The above configuration allows electricity to be charged (sold) from an electric vehicle which has a sufficient electric power quantity to a charging facility the electric power state of which is tough. Further, an electric vehicle which has an insufficient electric power quantity can be charged with electricity (purchase electricity) from a charging facility the electric power state of which is stable.

### (Supplementary Note 15)

A management method including:
acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
transmitting information pertaining to the target area to at least one of the extracted at least one electric vehicle.

The above configuration allows electricity to be charged (sold) from an electric vehicle which has a sufficient electric power quantity to a charging facility the electric power state of which is tough. Further, an electric vehicle which has an insufficient electric power quantity can be charged with electricity (purchase electricity) from a charging facility the electric power state of which is stable.

### (Supplementary Note 16)

A management apparatus including at least one processor, the at least one processor carrying out:
(a) a process for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
(b) a process for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
(c) a process for transmitting information pertaining to the target area to at least one of the extracted at least one electric vehicle.

Note that the management apparatus may further include a memory, which may store a program for causing the at least one processor to carry out the process (a), the process (b), and the process (c). The program may be stored in a non-transitory tangible computer-readable storage medium.

### (Supplementary Note 17)

A management system including at least one processor, the at least one processor carrying out:
(a) a process for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
(b) a process for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
(c) a process for transmitting information pertaining to the target area to at least one of the extracted at least one electric vehicle.

Note that the management system may further include a memory, which may store a program for causing the at least one processor to carry out the process (a), the process (b), and the process (c). The program may be stored in a non-transitory tangible computer-readable storage medium.

### REFERENCE SIGNS LIST

1 Management apparatus
1A, 1B, 1C Information processing apparatus
10A, 10B, 10C Control section
11 Acquisition section (acquisition means)
12, 12B Extraction section (extraction means)
13 Transmission section (transmission means)
14 Transmission information generation section
15 Determination section
20A Storage section
40A Communication section
100 Management system
121 Priority assigning section

What is claimed is:

1. A management apparatus comprising at least one processor, the at least one processor carrying out:
a process for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
a process for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
a process for transmitting information pertaining to the target area to at least one of the extracted at least one electric vehicle.

2. The management apparatus according to claim 1, wherein
the information pertaining to the target area includes position information of the one or more charging facilities in the target area.

3. The management apparatus according to claim 1, wherein
the information pertaining to the target area includes information pertaining to at least one of a selling price and a purchase price of electric power in each of the one or more charging facilities in the target area.

4. The management apparatus according to claim 1, wherein
in a case where the electric power state indicates an oversupply of electric power, in the process for extracting, the at least one processor extracts the at least one electric vehicle which is among the plurality of electric vehicles and the electric power quantity of which is not more than a first threshold.

5. The management apparatus according to claim 4, wherein
the information pertaining to the target area includes information indicating that charging is recommended in the one or more charging facilities in the target area.

6. The management apparatus according to claim 1, wherein
in a case where the electric power state indicates an electric power shortage, in the process for extracting, the at least one processor extracts the at least one electric vehicle which is among the plurality of electric vehicles and the electric power quantity of which is not less than a second threshold.

7. The management apparatus according to claim 6, wherein
the information pertaining to the target area includes information indicating that discharging is recommended in the one or more charging facilities in the target area.

8. The management apparatus according to claim 4, wherein
in a case where the extracted at least one electric vehicle comprises a plurality of electric vehicles,
in the process for extracting, the at least one processor
assigns priorities to the respective extracted plurality of electric vehicles, and
transmits the information pertaining to the target area to an electric vehicle that has a relatively high priority.

9. The management apparatus according to claim 8, wherein
in the process for extracting, the at least one processor assigns the priorities to the respective plurality of electric vehicles in accordance with an electric power quantity of each of the plurality of electric vehicles.

10. The management apparatus according to claim 8, wherein
in the process for extracting, the at least one processor assigns a relatively high priority to an electric vehicle that is among the plurality of electric vehicles and that is at a relatively short distance from at least one of the one or more charging facilities.

11. The management apparatus according to claim 8, wherein
the at least one processor carries out a process for determining that any of the plurality of electric vehicles has been subjected to charging or discharging, and
in the process for transmitting, the at least one processor transmits, in accordance with a determination result, the information pertaining to the target area also to an electric vehicle that has a relatively low priority.

12. The management apparatus according to claim 11, wherein
in the process for determining, the at least one processor determines, with reference to (i) position information pertaining to each of the plurality of electric vehicles and (ii) position information of the one or more charging facilities in the target area, that any of the plurality of electric vehicles has been subjected to charging or discharging.

13. The management apparatus according to claim 11, wherein
in the process for determining, the at least one processor determines, with reference to information which has been acquired from at least one of the plurality of electric vehicles and which indicates that the at least one of the plurality of electric vehicles has been subjected to charging or discharging, that the at least one of the plurality of electric vehicles has been subjected to charging or discharging.

14. A management system comprising at least one processor, the at least one processor carrying out:
a process for acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
a process for extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
a process for transmitting information pertaining to the target area to at least one of the extracted at least one electric vehicle.

15. A management method comprising:
acquiring (i) electric power state information indicative of an electric power state in a target area including one or more charging facilities and (ii) electric power quantity information indicative of an electric power quantity of each of a plurality of electric vehicles capable of being subjected to charging and discharging in the target area;
extracting, on the basis of the electric power quantity of each of the plurality of electric vehicles, the electric power quantity being indicated by the electric power quantity information, at least one electric vehicle that is among the plurality of electric vehicles and that corresponds to the electric power state in the target area; and
transmitting information pertaining to the target area to at least one of the extracted at least one electric vehicle.
